(19) United States
(12) Patent Application Publication
(10) Pub. No.: US 2019/0376634 A1
(43) Pub. Date: Dec. 12, 2019

(54) TRENCHLESS MECHANICAL LINING SYSTEM FOR CONTINUOUS REPAIR OF UNDERGROUND PIPES AND CULVERTS, AND METHOD OF INSTALLATION

(71) Applicant: LINK-PIPE, INC, Richmond Hill (CA)

(72) Inventors: Lembit Maimets, Toronto (CA); Kenneth Kim Enriquez, North York (CA)

(73) Assignee: LINK-PIPE, INC, Richmond Hill (CA)

(21) Appl. No.: 16/437,295

(22) Filed: Jun. 11, 2019

Related U.S. Application Data
(60) Provisional application No. 62/683,452, filed on Jun. 11, 2018.

(51) Int. Cl. F16L 55/163; F16L 55/18

(52) U.S. Cl. CPC F16L 55/163; F16L 55/18

(57) ABSTRACT

A trenchless mechanical lining apparatus for continuous repair of underground pipes and culverts, and a method of installation. The apparatus includes a plurality of core elements, each having a first end and a second end, the second end being an enlarged receiving end configured to receive a first end of a successive one of the core elements; a sealant to secure a first end of a first core element to a second end of a second core element; the core elements having lengths configured to span a length of a repair site; and a system for applying longitudinal pressure to secure the first core element to the second core element, the system including a cable and securing device, the latter configured to be attached to an end of an enlarged receiving end, and a pressure-applying device for forcing the first and second core elements together.

This application is based upon U.S. Provisional Patent Application No. 62/683,452, filed Jun. 11, 2018, the disclosure of which is hereby incorporated by reference thereto in its entirety, and the priority of which is claimed under 35 USC § 119(e).

### BACKGROUND

### 1. Field of the Invention

The invention relates to methods and apparatuses for repairing pipes, or conduits, particularly underground conduits, such as wastewater culverts and other types of conduits. More particularly, the invention is directed to methods and apparatuses for so-called “no-dig” repairs, such as for relining sections of damaged, weakened, or leaking conduits.

### 2. Background Information

Over a period of time, conduit systems for carrying water or wastewater become damaged, weakened, or otherwise begin to deteriorate and leak at the joints between adjacent sections. Such deterioration is caused by the settling of the surrounding earth adjacent the conduit system, by deterioration of the joints themselves over time, and/or by the growth of roots from trees and other plants.

Methods and apparatuses have been developed for repairing a damaged conduit section from within, and without the need for excavation. Such no-dig systems typically use a grout material for sealing cracks and joints, for example. It is also known in the art to re-line damaged conduit sections with a liner that is expanded from a coiled or otherwise collapsed configuration to a final configuration in which the liner is secured against the inner surface of the damaged conduit section.

Examples of such no-dig systems include those of Link-Pipe, Inc., disclosed in U.S. Pat. Nos. RE. 30,929, 5,119,862; 5,351,720; and 5,465,758, the disclosures of which are hereby incorporated by reference thereto in their entireties.

Also known in the field of no-dig, or trenchless, pipe repair systems is what is known as the Insta-Liner™ system by Link-Pipe, Inc., which was developed for the continuous repair of long sections of underground pipes and culverts. The so-called core element of the Insta-Liner™ system is stainless steel, with diameters from 6″ up to 54″ and section lengths of 18″, 24″, 36″, and 48″ being standard. The annular space between the stainless steel core is filled with grout, such as either a chemical (polyurethane) grout or a cementitious grout, depending upon the application. Stainless steel protects the grout from exposure to the environment and adds structural strength to the repair. The ends of adjacent sections of the core elements are joined by means of a flexible band at the time of installation. The result is a cured-in-place pipe repair with a Stainless Steel Protective Cover that has a longer life expectancy and is achieved at an average installed cost that is less than conventional repair methods relying upon excavation.

A six-page document of Link-Pipe, Inc., entitled “INSTA-LINER™ General Product Specification and Installation Instructions,” including FIGS. 1, 1a, 2, 2a, 3, 3a 4, 4a, 5, 5a, 6, 6a, 7, and 7a, Jun. 18, 2018, is part of this application.

### SUMMARY

The invention is directed to a trenchless mechanical lining apparatus for continuous repair of underground pipes and culverts, and method of installation.

More particularly, the invention is directed to a system and installation method that provides an alternative and improvement on the aforementioned Insta-Liner™ system and method of Link-Pipe, Inc.

### BRIEF DESCRIPTION OF DRAWINGS

Features and advantages of the present invention will become apparent from the detailed description of exemplary embodiments of the invention, which follows, when considering in the light of the accompanying drawings, in which:

FIG. 1 is a schematic longitudinal sectional view illustrating a pair of successive spaced-apart core elements of a first embodiment of an apparatus of the invention within a host pipe, with sealant having been applied to an end of an upstream one of the core elements prior to joining within a bell cone end of a downstream core element;

FIG. 2 is a schematic longitudinal sectional view similar to FIG. 1, but showing the aforementioned two core elements being joined with sealant sealing their respective ends;

FIG. 3 is a schematic longitudinal sectional view of FIG. 2, with hooks applied to the upstream (bell cone) end of the upstream core element, with a cable extending upstream where can be pulled by a winch or other device;

FIG. 3.1 is an enlarged view of FIG. 3, illustrating the cylindrical end of the upstream core element mated with the bell cone end of the downstream core element, with sealant between their mating surfaces;

FIG. 3.2 is also an enlarged view of FIG. 3, illustrating a lower one of the aforementioned hooks applied to the upstream end of the upstream core element;

FIG. 4 is a schematic longitudinal sectional view, similar to that of FIG. 2 of the first embodiment, illustrating a pair of successive spaced-apart core elements of a second embodiment of an apparatus of the invention within a host pipe, showing the two core elements being joined with sealant sealing their respective ends; and

FIG. 4.1 is an enlarged view of FIG. 4, illustrating the cylindrical end of the upstream core element of the second embodiment mated with the enlarged end of the downstream core element, with sealant between their mating surfaces.

### DETAILED DESCRIPTION

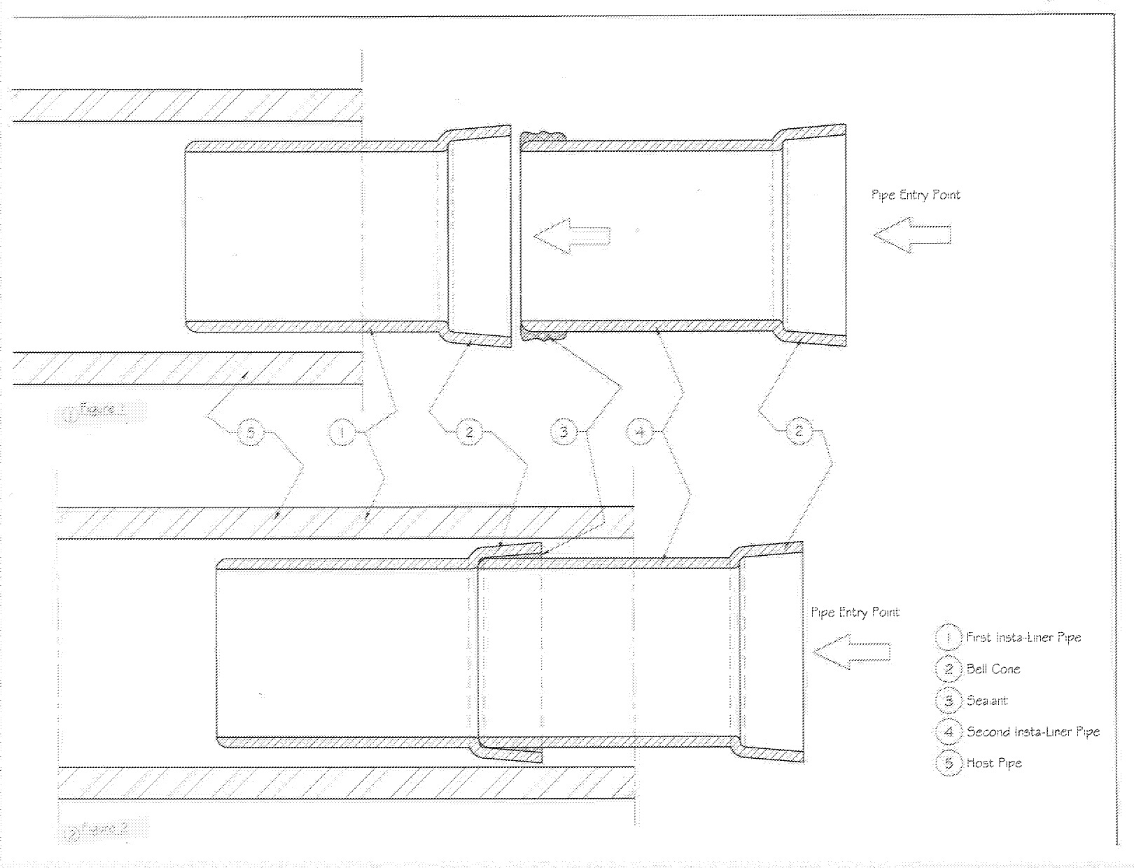

The invention is directed to a trenchless mechanical lining apparatus for continuous repair of underground pipes and culverts, and method of installation. As stated above, the invention is directed to a system and installation method that provides an alternative and improvement on the aforementioned Insta-Liner™ system and method of Link-Pipe, Inc. Accordingly, the aforementioned document of Link-Pipe, Inc., entitled “INSTA-LINER™ General Product Specification and Installation Instructions,” the disclosure of which is hereby incorporated by reference thereto in its entirety, particularly for features, such as features of the method of installation of the apparatus illustrated in FIGS. 1, 2, 3, 3.1, 3.2, 4, and 4.1 that are not inconsistent with the following description nor that which is shown in FIGS. 1, 2, 3, 3.1, 3.2, 4, and 4.1.

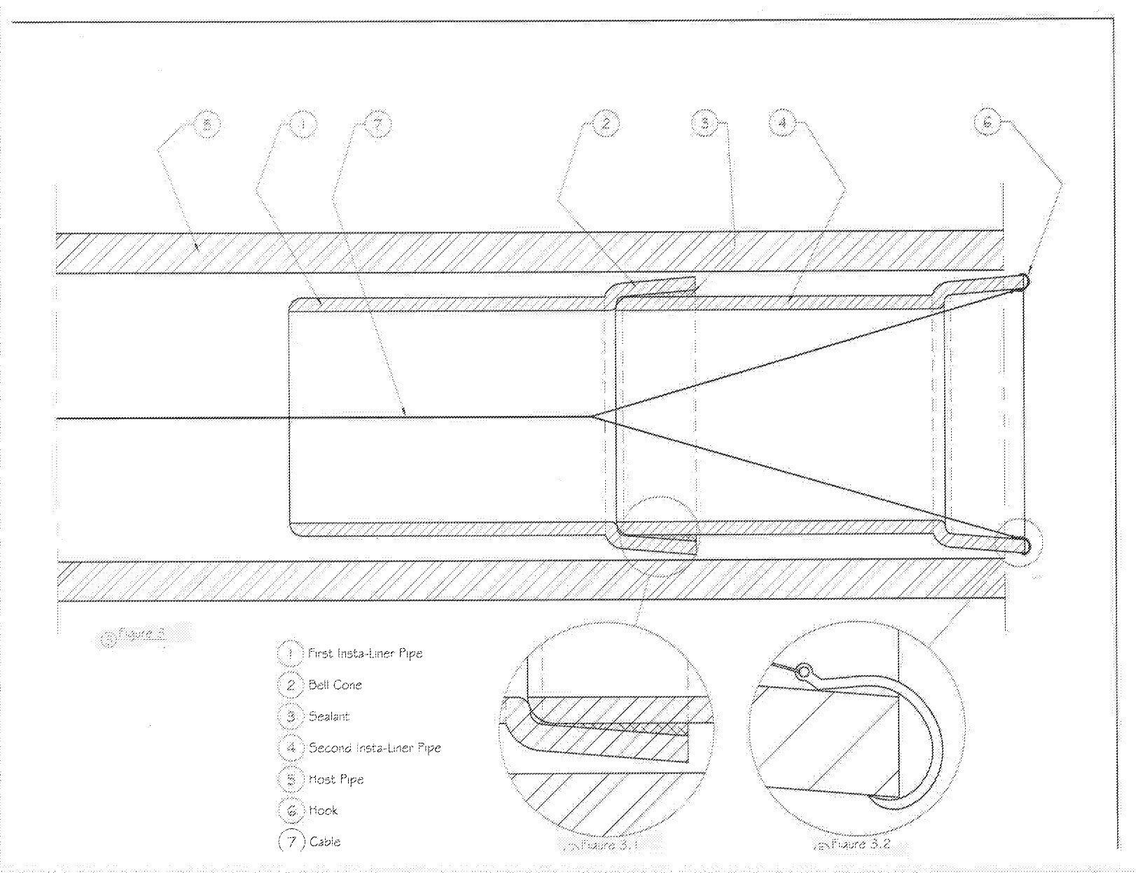

As shown in FIGS. 1-4, the core element 1 of the invention, which can be made of stainless steel, includes a cylindrical pipe portion that extends from a downstream end to a bell cone 2 at the upstream end. Although the terms “upstream” and “downstream” are used for convenience, the core elements can be assembled otherwise, with the terms being reversed with regard to how successive core elements are connected. The bell cone 2, which includes a conical section enlarging in the downstream-to-upstream direction so that a downstream cylindrical end of a successive core element can be received and fitted, as shown in FIG. 2, for example, and described further below. The bell cone can more generally described as an enlarged receiving end of a core element.

The bell cone 2 can be formed by means of a tube end forming operation, such as rolling or other technique known to those skilled in the art, made to the end of a cylindrical sleeve, such as a metal sleeve, such as made of stainless steel.

Before the end of a second (upstream) core element is fitted to a downstream bell cone portion of a first (downstream core element) the outer circumference of the cylindrical end region of the upstream core element, as shown in FIG. 1.

Then, the upstream core element is inserted into the downstream core element as the sealant is forced into the annular space between the outer surface of the cylindrical end of the upstream core element and the inner surface of the conical end of the bell cone 2 of the downstream core element, as shown in FIG. 2.

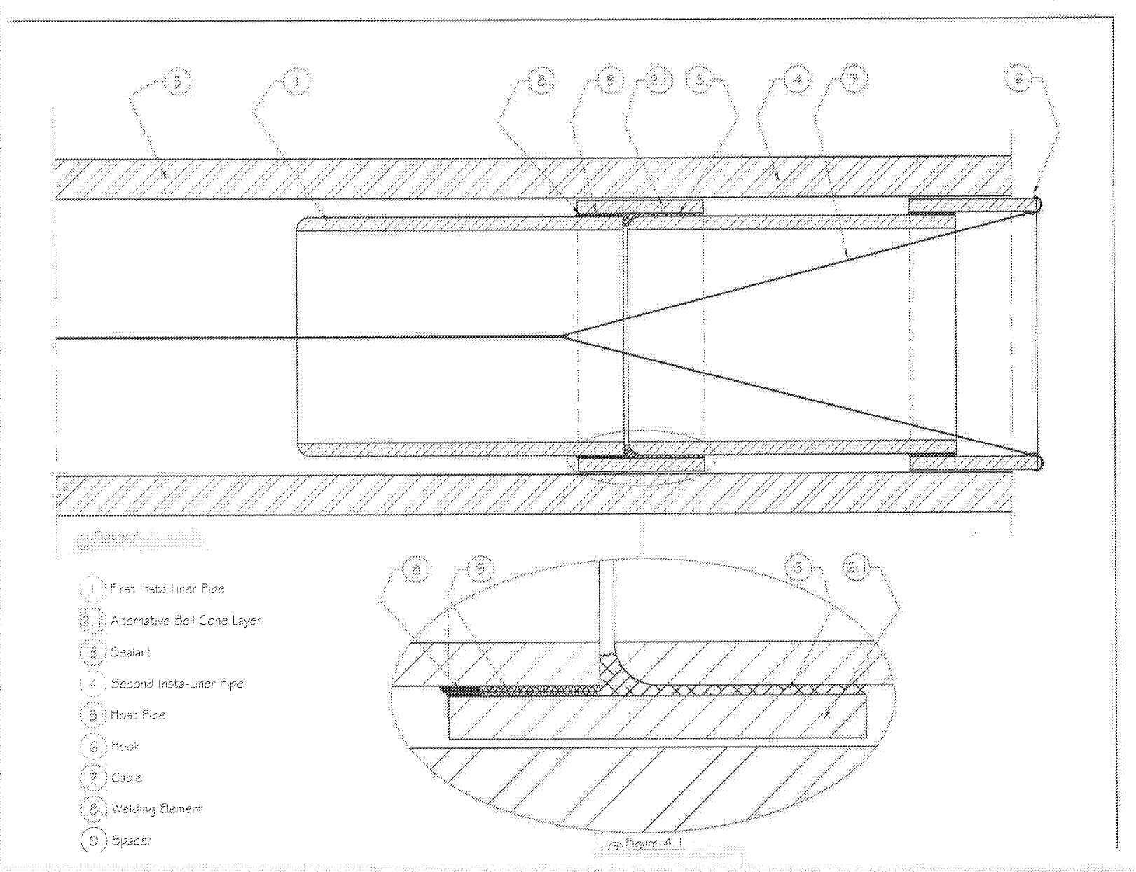

Once the two core elements 1, i.e., the aforementioned downstream and upstream elements, are connected, hooks 6 are attached to the edges of the bell cone 2 of the upstream core element, as shown in FIG. 3. A cable 7 is connected to each of the hooks and extends downstream to a winch or other device that can apply a pulling force to tighten the connection between the two successive core elements 1.

The securing of adjacent core elements 1, as shown in FIG. 3, differs from the way a pair of core elements are joined together in the aforementioned prior Insta-Liner™ system, which uses a third piece, that is, band that surrounds the ends of the adjoining core elements.

Although two hooks 6 are illustrated in FIG. 3, more than two hooks are within the scope of the invention. Also, as an alternative to the use of hooks, the cable 7 can be secured to an annular member that has a circular groove that fits the projecting end edge of the bell cone 2.

After the two core elements are forced together, the hooks are removed so that a successive core element 1, that is, a third core element, can be fitted in a downstream direction into the second core element. Then, the procedure described above can be repeated, thereby extending the length of the core element to the length necessary for the desired repair of the damaged host pipe 5. All core elements 1 can be assembled in advance and then inserted within the host pipe, although if area is restricted, then can be installed and connected one-by-one within the host pipe. Also, although grout can be installed between the core elements ii and the host pipe 5 by means of known methods, the installation can be accomplished without grout. For example, in cases where in the sequentially formed core elements 1 are fixed and secured in place where there is laminar flow, then grout can be omitted. However, in cases where there is turbulent flow that creates instability to the core elements, then grout can be applied.

FIGS. 4 and 4.1 illustrate a second alternative, embodiment of the invention. In this second embodiment, FIG. 4 depicts a sectional view similar to that of FIG. 2 of the first embodiment, illustrating a pair of successive spaced-apart core elements having an alternative to the bell cone of the first embodiment.

In the second embodiment, a cylindrical element 2.1 is welded to an upstream end of a core element 1, with an appropriate lengthwise projecting portion providing an enlarged receiving area of a second (upstream) core element and its sealant 3, as shown in FIG. 4.1.

FIG. 4.1 also shows the weld being accomplished by means of a welding element 8 and a metallic spacer 9.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

1. A trenchless mechanical lining apparatus for continuous repair of underground pipes and culverts, said apparatus comprising:
a plurality of core elements, each of the core elements having a first end and a second end, the second end being an enlarged receiving end configured to receive a first end of a successive one of the plurality of core elements;
sealant for application to secure a first end of a first core element to a second end of a second core element;
the plurality of core elements having lengths configured to span a length of a repair site of a host pipe;
a system for applying longitudinal pressure to secure the first core element to the second core element, said system comprising a cable and securing device, the securing device configured to be attached to an end of enlarged receiving end, and a pressure-applying device for forcing the first and second core elements together.

2. The apparatus of claim 1, wherein:
the enlarged receiving end of each of the plurality of core elements comprising a bell cone.

3. The apparatus of claim 1, wherein:
the enlarged receiving end of each of the plurality of core elements comprising a cylindrical welded element

4. A method of installing the apparatus of claim 1 within an inner wall of the host pipe.
